(19) United States
(12) Patent Application Publication
(10) Pub. No.: US 2006/0191383 A1
(43) Pub. Date: Aug. 31, 2006

(54) MULTIPLE BIT TOOL SYSTEM

(76) Inventors: Anthony Todd Woods, Longmont, CO (US); Michael J. Barrowman, Thornton, CO (US)

Correspondence Address: GLENN L. WEBB, P.O BOX 951, CONIFER, CO, 80433, US

(21) Appl. No.: 11/163,850

(22) Filed: Nov. 1, 2005

Related U.S. Application Data
(60) Provisional application No. 60/522,738, filed on Nov. 2, 2004.

(51) Int. Cl. B25B 13/00

(52) U.S. Cl. 81/124.4; 81/177.85

(57) ABSTRACT

The present invention relates to tools and in particular to a new and improved magnetic hexagonal nut driver used to drive the fastener heads of either screws or bolts.

### FIELD OF THE INVENTION

This invention relates to the field of hexagonal nut drivers used to drive the fastener heads of fasteners.

### BACKGROUND OF THE INVENTION

Most fasteners in many industries are typically one of three standard sizes. For example, in the Heating Ventilation and Air Conditioning (HVAC) industry, as well as the office furniture and household appliances industries, three standard sizes of fasteners make up the majority of all fasteners used. Regardless of whether the use is for residential or commercial applications, ¼ inch, 5/16 inch and ⅜ inch hexagonal sheet metal nuts (Hex nuts) are the most commonly used fasteners.

Nut drivers are devices generally known in the trades as hand tools or as motor-driven tools for applying and removing these types of fasteners. These nut drivers are commonly used to secure nuts on bolts; for driving and removing bolts; or for driving and removing screws.

As a result, to service these appliances and industries, it is quite common to use three separate and distinct hex nut driver tools during the assembly and disassembly of major appliances, HVAC ductwork and equipment, office furniture components or other applications, including home, commercial, and industrial applications.

For example, when unpackaging a rooftop air conditioning unit a ⅜ inch hex nut driver is needed; to gain access inside the AC units though its doors, a 5/16 inch hex nut driver is used; and if internal components like motors or igniters are serviced usually still another hex nut driver, a ¼ inch size is required.

Most motor-driven tools such as power drills incorporate a bit holder, also known as a chuck, for receiving interchangeable devices such as nut drivers and drill bits. When a job calls for a specific size of fastener to be secured or removed, for example a quarter-inch sheet metal screw, the corresponding nut driver size is used. If a smaller or larger faster is needed later, in this case perhaps a three-eights inch screw, the previous quarter-inch nut driver is removed from the power drill and replaced with the appropriately sized three-eights inch nut driver. And herein lies the problem. For those working in these industries, they seem to be spending a lot of time swapping three different sized nut drivers in and out of their power drills all day long. This problem is complicated because often times the size needed has been misplaced or lost so that a trip to the truck or a toolbox to find the missing tool is required. This can be time consuming and costly, especially if replacement parts need to be purchased.

With the need for three separate tools to service these trades, it is clear that nowadays working these industries can be unnecessarily time consuming and annoying and there is a specific need for a single tool to replace the three currently being used. The solution to this problem is the primary object of this invention.

### SUMMARY OF THE INVENTION

The present invention solves these and other problems by providing a nut driver tool that can handle most common sizes of fasteners. The nut driver tool includes a set of stacked driver sockets that are sized to fit most common sizes of fasteners. The driver sockets are securely engaged to one another but are easily separated when the size of socket is to be changed.

The nut driver tool of the preferred embodiment includes three differing sizes of sockets that encompass most commons sizes of fasteners. In this preferred embodiment, the sockets include one-quarter inch, five-sixteenths inch and three-eighths inch. The sockets are hexagonal shaped to fit those fasteners.

The sockets of a preferred embodiment include magnetic engagement mechanisms. These engagement mechanisms secure the sockets in a stack to one another. This engagement mechanism also allows the sockets to be disengaged from one another in a easy and quick manner.

The device of this preferred embodiment allows the appropriate size of nut driver to be easily accessible without the need to change the tool itself from the drill.

This device allows the correct size of driver to easily accessible as needed. If you need to drive a ¼-inch fastener you have immediate access because that is the first socket visible in the set. If you need to access the 5/16-inch size, simply use the thumb pulls to quickly and easily remove the ¼ socket and the 5/16-inch nut driver is available. For fasteners that require the ⅜-size nut driver, simply remove the 5/16 nut driver, which may or may nor be attached to the ¼-inch, and the ⅜ size is accessible and ready to use. And never once would you have to change the tool from the drill chuck. As subsequent sizes are accessed and used throughout the course of a task or project, the tool can simply and easily be reconnected with the magnets and self-fitting assembly. It's as simple as putting the correctly sized hex shape into the matching hex shape hole.

These and other features will be evident from the ensuing detailed description of embodiments and from the drawings.

### BRIEF DESCRIPTION OF THE DRAWINGS

FIG. 1 illustrates an assembled nut driver tool of a preferred embodiment of the present invention.

FIG. 2 illustrates a disassembled view of the embodiment of FIG. 1.

FIG. 3 illustrates the components of the embodiment of FIG. 1.

FIG. 4 illustrates a partially assembled view of the embodiment of FIG. 1.

FIG. 5 illustrates a view of the tool of FIG. 1 mounted in a power drill.

### DETAILED DESCRIPTION OF PREFERRED EMBODIMENTS

The present invention, in a preferred embodiment, provides an improved tool for securing fasteners in most applications. A preferred embodiment of the present invention is described below. It is to be expressly understood that this descriptive embodiment is provided for explanatory purposes only, and is not meant to unduly limit the scope of the present invention as set forth in the claims. Other embodiments of the present invention are considered to be within the scope of the claimed inventions, including not only those embodiments that would be within the scope of one skilled in the art, but also as encompassed in technology developed in the future.

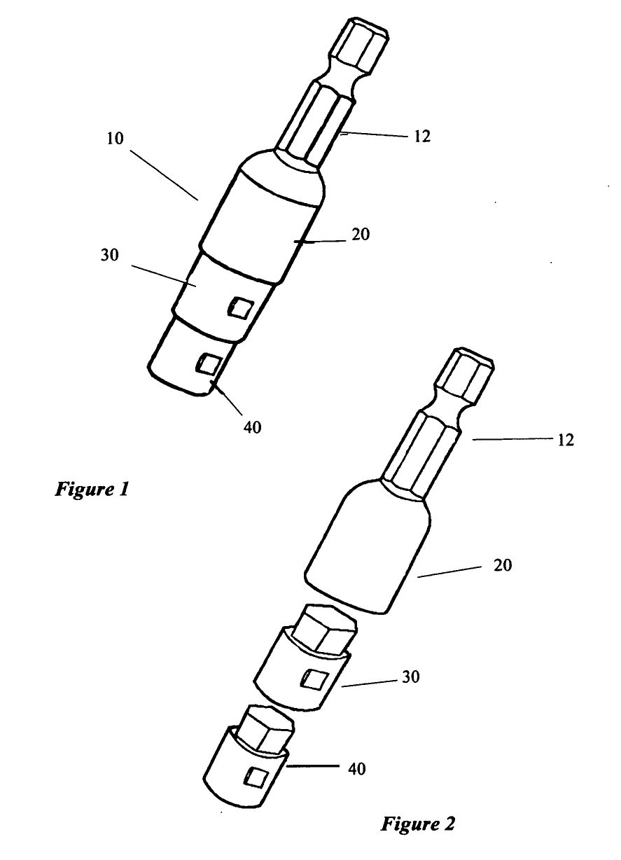

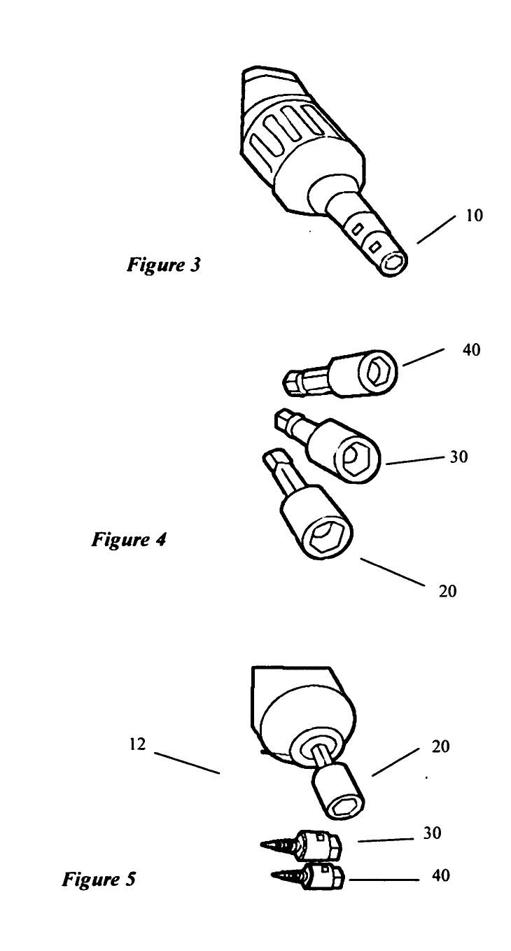

A preferred embodiment of the present invention is illustrated in FIGS. 1-5. This embodiment of the present invention is a multiple bit magnetic hexagonal nut driver tool 10 for use in power drills. This preferred embodiment of the current invention is a self-contained multi-use tool consisting of a set of three magnetic nut drivers or sockets 20, 30, 40. Each of the three nut drivers has a hexagonal working end with a cavity specifically sized to a corresponding industry standard fastener head. Those cavity sizes are quarter inch, five-sixteenths inch, and three-eighths inch, This invention is not limited to only these sizes and may include metric sizes as well.

It is to be expressly understood that while the above descriptive embodiment is directed to specifically sized hexagon nut driver, that other shapes and sizes may be used as well. Also, a non-magnetic nut driver may be used as well. Also, the nut driver may be used in a manual form with a handle, ratchet or other mechanism or else formed integrally with a power tool. Also, the nut driver may have differing numbers of sockets as well in lieu of the three described herein.

The nut driver tool of this preferred embodiment is comprised of a first hexagonal socket 20 (¼ inch), attached to a second hexagonal socket 30 ( 5/16 inch), attached to a third hexagonal socket 40 (⅜ inch) which also includes a industry standard ¼ inch hex shank 12 for insertion into the bit holder or chuck of the power drill. The length of the shank is ⅞ inch long but is not limited to this size.

In addition, each nut driver has an appropriate sized shank that is used to join it to the next size nut driver in the set. The first nut driver, the ¼ size will accept a ¼ inch hex nut fastener and has a 5/16 shank which allows it to be mated with the 5/16 inch nut driver. The 5/16 nut driver, or the second in the set of three, will accept a 5/16 hex nut fastener and has a ⅜ shank which allows it to be mated with the ⅜ inch nut driver which is the third in the set and will accept a ⅜ inch hex nut fastener. This third nut driver also includes the shank to be inserted in the bit holder of power drills.

The size of the first and second socket shanks used to connect the three together is ⅜ inch in height but is not limited to only this size and they in fact be of multiple sizes within the tool. This invention is not limited to only these sizes and may include metric sizes as well. In addition, both the first and the second sockets have recessed notches that serve as thumb pulls to easily separate the tool and gain access to the desired size.

In addition to the mechanical mating of these three nut drivers, they are also held together utilizing magnets. The magnets are ⅜-inch diameter and ⅛ in height. The invention is not limited to a specific size and strength of magnet nor a specific attachment process.

The height of the first nut driver socket is ½ inch tall and 7/16-inch diameter. The second socket is 7/16 inch in height and has a ½-inch diameter. The third socket in the nut driver tool has a ⅞ -inch height and a 9/16 diameter. The invention is not limited to these heights and diameters and may include various combinations of sizes.

The invention is constructed of hardened steel but is not limited to that process and may include heat-treated and tempered steel and precision machining manufacturing among others.

It is to be expressly understood that this invention is not limited to the sizes of the described sockets or even to sockets. Other types of tool bits may be used as well, such as Phillips, flat head or torque screw bits, or other types of tool bits.

### Application of the Preferred Embodiment

The rapid storage, retrieval and use of a predetermined tool during an assembly or disassembly project, is a very desirable goal. It is desirable because having immediate access to commonly used tools makes the work being performed faster and easier. This efficiency can result in a time and a cost savings for many people involved.

The multiple bit nut driver is designed to be used as a single tool capable of replacing three or more separate nut drivers of different sizes. It is designed for use with either motor-driven tools such as a power drill or electric screwdriver or hand tools. It combines popular sizes such as a ¼ inch, 5/16 inch, and ⅜ inch nut driver socket into one easy to use tool. Because the vast majority of fasteners are either ¼ inch, 5/16 inch, or ⅜ inch this provides a great convenience because no matter what size that is needed, this nut driver provides immediate access to all three sizes in a single tool. It is to be expressly understood that other sizes may be used as well.

Whether it's used for mechanical fasteners or self-drilling screws the multiple bit magnetic nut driver allows for rapid size changes without having to add and remove individual nut driver bits each time from the power drill's bit holder or chuck. The multiple bit nut driver is a single tool that's less than 3 inches long. Each individually sized hex nut driver is specifically designed to be mated with the next size nut driver in the set. In each of these, a permanent magnet is held at the base of the bore of a socket that not only holds each of the three drive sockets together but also utilizes magnetic forces to maintain a fastener in connection with the driver socket. Attached together in ascending order, the first nut driver is the commonly used ¼ inch size, followed by the 5/16 inch, followed by the ⅜ inch hex nut driver which includes a standard hex shank for insertion into drill chucks. Simply insert the tool's shank into a power drill's chuck and you have 3 tools ready to use at a moments notice.

This embodiment allows immediate access to a first size fastener driver, such as a ¼-inch fastener since it is the first socket visible in the set. Access to a second fastener size, such as the 5/16-inch size, simply use the thumb pulls to quickly and easily remove the ¼ socket and the 5/16-inch nut driver is available. For fasteners that require the ⅜-size nut driver, simply remove the 5/16 nut driver, which may or may nor be attached to the ¼-inch, and the ⅜ size is accessible and ready to use. The tool never needs to be changed from the drill chuck. As subsequent sizes are accessed and used throughout the course of a task or project, the tool can simply and easily be reconnected with the magnets and self-fitting assembly. It's as simple as putting the correctly sized hex shape into the matching hex shape hole.

In addition, by using smaller components in the design of the tool—specifically the ¼ inch and 5/16 inch nut drivers—there is also a potential cost savings. Since neither of these requires the use of an extended shank and subsequent material needed to attach to the drill, there is the possibility of lower overall cost when compared to buying three separate individually sized tools.

### SUMMARY

Based on the information above, it can be seen that there is a single, easy to use, low cost tool, which takes the place of three separate tools. These tools, typically called hex nut drivers, are specifically designed for driving fasteners—the most common of which are the ¼ inch, 5/16 inch, and ⅜ inch sizes.

The design of the multiple bit nut driver and its sockets permit the assembly and reassembly of the three nut driver members with respect to each other, to create either a one-piece, two-piece or three-piece tool, depending on what size nut driver socket is chosen. This relative positioning of the individual sockets, within the set of three, accomplishes the goal of saving time by creating one tool that accomplishes the task of three.

Having the right tool at the right time is critical to those servicing the HVAC, appliance, and office furniture industries. And there's nothing convenient or efficient about carrying around a bunch of tools, especially if one . . . , can do the job of many.

What is claimed is:

1. A nut driver tool for driving fasteners, said tool comprising:
a shank for manipulating said tool;
a first socket attached to said shank for engaging a first size of fastener;
a second socket for engaging a second size of fastener;
a third socket for engaging a third size of fastener;
a first engagement mechanism for securing said third socket to said second socket; and
a second engagement mechanism for securing said second socket to said first socket.

2. The nut driver tool of claim 1 wherein said tool further includes:
a first hex shaped aperture on said first socket for engaging said first size of fastener;
a hex shaped head on said second socket for engagement in said first hex shaped aperture on said first socket;
a second hex shaped aperture on said second socket for engaging said second size of fastener; and
a hex shaped head on said third socket for engagement in said second hex shaped aperture on said second socket.

3. The nut driver tool of claim 1 wherein said tool further includes:
a first magnetic member in said first socket for engaging said second socket; and
a second magnetic member in said second socket for engaging said third socket.

4. The nut driver tool of claim 1 wherein said tool further includes:
a first hex shaped aperture on said first socket for engaging said first size of fastener;
a first magnetic member in said first socket for engaging said second socket;
a hex shaped head on said second socket for engagement in said first hex shaped aperture on said first socket;
a second hex shaped aperture on said second socket for engaging said second size of fastener;
a second magnetic member in said second socket for engaging said third socket; and
a hex shaped head on said third socket for engagement in said second hex shaped aperture on said second socket.

5. The nut driver tool of claim 1 wherein said tool further includes:
an engagement surface on said shank for engagement by a power driver.

6. The nut driver tool of claim 1 wherein said tool further includes:
an engagement surface on said shank for engagement by a hand tool.

7. The nut driver tool of claim 1 wherein said tool further includes:
a plurality of sockets; and
each of said sockets having engagement mechanisms for engaging another of said sockets.

8. The nut driver tool of claim 1 wherein said tool further includes:
said third socket including a bit for engaging a fastener.

9. The nut driver tool of claim 9 wherein said bit includes:
a flat head bit.

10. The nut driver tool of claim 9 wherein said bit includes:
a Phillips head bit.

11. The nut driver tool of claim 9 wherein said bit includes:
a torque head bit.

12. The nut driver tool of claim 1 wherein said tool includes:
one of said sockets including an engagement mechanism for engaging other sizes of sockets.
